(19) United States
(12) Patent Application Publication
(10) Pub. No.: US 2016/0142879 A1
(43) Pub. Date: May 19, 2016

(54) ESTABLISHMENT BASED SOCIAL NETWORKING SYSTEM

(71) Applicants: Michael Walden, Dallas, TX (US); Jeffrey Brian Weisberg, Miami, FL (US)

(72) Inventors: Michael Walden, Dallas, TX (US); Jeffrey Brian Weisberg, Miami, FL (US)

(21) Appl. No.: 14/873,951

(22) Filed: Oct. 2, 2015

Related U.S. Application Data
(60) Provisional application No. 62/059,620, filed on Oct. 3, 2014.

(51) Int. Cl. H04W 4/02; H04W 4/00; H04W 12/08

(52) U.S. Cl. CPC H04W 4/025; H04W 12/08; H04W 4/001; H04W 84/18

(57) ABSTRACT

The present invention is a conventional mobile wireless communications device including a location based ad hoc network system, using a location beacon and wireless device management software. When a wireless device comes in range of the beacon signal, the wireless device will see the presence of the beacon, and when the beacon is selected, the wireless device is now enabled to potentially communicate with all other such enabled wireless devices. Then, the wireless device management application (App) of this invention, which each such enabled wireless devices will have installed, acts to manage access to and between the wireless communications devices. The communication with other such enabled wireless devices may be under anonymous conditions or with various amounts of disclosure, including personal information. Upon completion of user-member communications, either user-member may request the other user-member to allow saving the content of the completed communications session, and if refused all information will be totally deleted upon the user-members disconnecting from each other and no history of the communications transactions is retained.

### BACKGROUND

This section is intended to introduce the reader to aspects of art that may be related to various aspects of the disclosure described herein and claimed below. This discussion is believed to be helpful in providing the reader with background information to facilitate a better understanding of the various aspects of the disclosure described herein. Accordingly, it should be understood that these statements are to be read in this light, and not as admissions of prior art.

Present social discovery mobile applications have a number of major problems including user personal information being exposed and potentially pilfered. Privacy concerns and relevancy to users in real time have caused traditional forms of social media to lose share to messaging and discovery apps. Today's social discovery apps don't offer their users real privacy, anonymity, safety, nor the ability to only be accessible by other individuals in the same “physical” establishment.

Hence, what is needed is an effective, secure, anonymous social discovery networking system that will provide security and protection of the user's personal information. Furthermore, the app should combine anonymous location-based chats with ephemeral (short lived, self-destructing) conversations, providing a bridge to the user's immediate community while providing compelling social features and content.

### BRIEF SUMMARY

The present invention is a conventional mobile wireless communications device including a location based ad hoc network system, using a location beacon and wireless device management software. When a wireless device comes in range of the beacon signal, the wireless device will see the presence of the beacon, and when the beacon is selected, the wireless device is now enabled to potentially communicate with all other such enabled wireless devices. Then, the wireless device management application (App) of this invention, which each such enabled wireless devices will have installed, acts to manage access to and between the wireless communications devices. The communication with other such enabled wireless devices may be under anonymous conditions or with various amounts of disclosure, including personal information. Upon completion of user-member communications, either user-member may request the other user-member to allow saving the content of the completed communications session, and if refused all information will be totally deleted upon the user-members disconnecting from each other and no history of the communications transactions is retained.

The communication with other such enabled wireless devices may be under anonymous conditions or with various amounts of disclosure, including personal information. Upon completion of user-member communications, either user-member may request the other user-member to allow saving the content of the completed communications session, and if refused all information will be totally deleted upon the user-members disconnecting from each other and no history of the communications transactions is retained.

In practical application, this system and method provides for private, controllable and safe social networking of wireless device users, such that, the system does not require any personal information to be transmitted over the internet. The system may provide personal information at the location of use, between the users' wireless devices, and this information not being exposed to the Internet reduces the potential for theft.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates an example of the App icon and displays the sign-up button.

FIG. 2 illustrates the signup registration process

FIG. 3 illustrates a screen where the App is displaying a timing graphic as part of the process of taking the prospective App user's profile picture for part of the Set-Up procedure.

FIG. 4 illustrates a screen where the example App is showing the user's ability to accept or reject their picture and its display on the wireless device screen.

FIG. 5 illustrates a screen where the example App is providing for prospective App user entry of profile information as part of the Set-Up procedure.

FIG. 6 illustrates a screen where the example App shows the types of communications available providing the ability to turn off or on the available communications.

FIG. 7 illustrates a screen of the example App showing all network locations that are available for selection from the current user-member's location, and the option for the user-member to create a particular establishment location and act as a temporary beacon.

FIG. 8 illustrates a screen where the example App displays thumbnails of all active users-members that are also at that particular establishment location.

FIG. 9 illustrates shows a screen where the example App's depicts settings providing the user-member means to select a reduced set of recipient user-members by employing filters using profile data, which dynamically change as the settings are adjusted.

FIG. 10 illustrates where the example App, after use of filters, user-member chooses the recipient user-member they wish to contact and possible methods of communications available and sends a message to the recipient user-member.

FIG. 11 illustrates a screen of the example App where the recipient user-member receives a notification that a user-member wishes to contact them and illustrates an example of a means to accept access or reject the offer to communicate.

FIG. 12 illustrates a screen where the example App is showing the members acceptance of the proposed communications and the following communications.

FIG. 13 illustrates where the example App is showing that the user-member has moved out of the particular establishment location geofence range and a screen appears above the present active screen, with a timer graphic, when this timer ends, all communications are deleted.

FIG. 14 illustrates where the example App is showing that the user-member has moved out of the geofence range and a screen appears above the present active screen, stating the communications link to the local network of the particular establishment location has been disconnected and all information has been deleted.

FIG. 15 illustrates shows the next screen where the example App shows what would appear on the screen during a voice call with another user-member

FIG. 16 illustrates the next screen where the example App shows what would appear when user clicks on picture as a means to communicate with another member

FIG. 17 illustrates the next screen where the example App shows what the user will see if they choose the option to select from an existing picture rather then take a new picture

FIG. 18 is a flow chart for an example of a sequence of operations

### DETAILED DESCRIPTION

In the Brief Summary of the present disclosure above and in the Detailed Description and the claims below, and in the accompanying drawings, reference is made to particular-features (including method steps) of the disclosure described herein. It is to be understood that the disclosure of the disclosure described herein in this specification includes all possible combinations of such particular features. For example, where a particular feature is disclosed in the context of a particular aspect or embodiment of the disclosure described herein, or a particular claim, that feature can also be used, to the extent possible, in combination with and/or in the context of other particular aspects and embodiments of the disclosure described herein, and generally in the disclosure described herein.

Phrases and terms similar to “Beacons” may include any device that transmits a signal which allows another device to determine its proximity to the broadcaster (the beacon), and other possible information. In a store, a beacon lets a customer's App determine that it's close to the candy aisle. The beacon doesn't transmit content; it simply transmits a signal that lets a user's phone or tablet figure out what its proximity to the beacon. The content (a coupon, for example) is delivered separately to the user's app from a from a cloud database server as a possibility. As used herein, the beacon may also be a light source transmitter or passive visual printed beacon, which may include a barcode or QR code, or the like. Additionally, the functions of the wireless beacon may be accomplished by a Wi-Fi hotspot at the particular establishment location, providing an intrinsic beacon signal, which may be utilized alone or in conjunction with other beacons, such as the printed QR beacon. Also, it is conceived that all beacons may be utilized together, in any combination, to provide a more effective result, including use with GPS location. Essentially, rather than using satellite signals to locate a device anywhere on Earth as GPS does, Bluetooth Low Energy (BLE). BLE can enable a mobile user to navigate and interact with specific regions or “geofenced” by low cost signal emitters or “Beacons”, that can be placed anywhere, including indoors, and even on moving targets. Additionally, it appears iOS devices can also act as a Beacon. Acting as Beacon, a user with an iOS 7 device in hand could trigger events around them, allowing them to, for example, turn on lights and unlock and open doors simply by signaling the user's proximity to devices listening for it via BLE. For a mobile device to receive beacon signals its Bluetooth® Smart radio must be switched on. An internet or mobile carrier network is required only when content delivery is expected to arrive to a mobile device from a cloud infrastructure. If content delivery is localized to the App a network connection is not required but Bluetooth® Smart remains a requirement to fulfill beacon signal reception. Most mobile devices today ship with Bluetooth® Smart and Wi-Fi already switched on. Information about the location is sent from the beacon as an Advertising packet is small, and because the device doesn't actually DO a lot, it's a low-energy specification which is both good for the beacon itself and good for the user's phone or tablet: it doesn't take a lot of energy to detect or broadcast a signal. Beacons can be uniquely identified as well since each beacon broadcasts its own ID. Every ID, like an IP number of each device, is 20 bytes long and is divided into three sections: proximity UUID (16 bytes)+major number (2 bytes)+minor number (2 bytes). ID example: c2d360a002a601315add1040f3913c300102.

Phrases and terms similar to “Beacon and Wireless Device Broadcasting range and proximity” may include the concept of viewing a beacon as a small lighthouse tower that's installed in a fixed location and broadcasts its presence to all the ships (Smartphones) around. They could be as little as 2 inches and as far as 230 feet (approx. 70 meters) away. The exact maximum range depends on the environment of course. Bluetooth is using the same type of radio waves as 2.4 Ghz Wi-Fi routers. The signal can be diffracted, interfered or absorbed by water (including the human body). This is possible, because the area around the beacon is divided logically into three “zones”: “immediate”, “near” and “far”, the same way they are visualized on the screen in the distance app. Whenever the user crosses the border between them, their context changes and a meaningful message is appropriate. Similarly to the other demo apps, the beacon broadcasts its ID and the receiving cell phone continuously monitors the strength of the signal, or RSSI (Received signal strength indication), but instead of showing it on a continuum, the phone checks which range the signal belongs to. The app, thanks to its internal settings, resolves which zone (immediate, near or far) the particular RSSI level belongs to. Whenever the user enters or leaves a zone an event is triggered, which is used to display a message on the screen. Also, keep in mind that it is perfectly possible to differentiate between the “enter” and “leave” events. Smartphone can pick up signal from more than one beacon at the same time. If there are three or more beacons within range, your phone can calculate the distance to each beacon and use this data to estimate its relative location. This technique is something that sailors had used for ages. They were navigating thanks to unique fixed markers like lighthouses or stars.

Phrases and terms similar to “Monitoring distance and triggering events” may include the act of the Smartphone continuous monitoring the strength of the signal (or RSSI), which is compared to three predefined ranges that divide the area around a beacon logged into three zones—far, near and immediate. The application is also notified which zone the phone is currently in. Whenever the user enters a zone, their context may change, so the OS notifies the application about this event as well.

Phrases and terms similar to “the act of the Context and micro-location from the cloud” may include the concept of once you get an ID and the distance (RSSI) to the beacon you get micro-location and context. You could now take detected ID and depending on the distance display different actions on the user's phone. Since beacons broadcast only tiny amount of information you have to fetch relevant content (e.g. picture of a shoe) from your local database or cloud-based storage.

Phrases and terms similar to “Beacon Management App” may include the concept of the ability you might need some way to change the firmware on a beacon. Because most beacons can't communicate directly with the Web because they lack a WiFi or other connection, you use an app that communicates with your beacon and updates its firmware.

Phrases and terms similar to “Beacon Management ‘Cloud” may include the concept that you have two choices for managing your app's response to beacons: hard code it into your app, or pull key data from the cloud. For example, you might start-network, provided by deploying 2 beacons. You could hard code their ID numbers into your app. But what happens if you add more beacons? Instead of updating the app itself, you can update the data on a server and your app can ‘pull’ this information. This puts the burden for keeping your list of beacons into a cloud service and means you don't need to push an app update every time you add a new beacon or want to change values that your app relies on the software App.

Phrases and terms similar to “Content Management System” may include the concept that: like most apps, you can either code content directly into your app or program your app so that it pulls from the ‘cloud’. For example, you might want a coupon to appear when a user is near a beacon. But instead of hard-coding the coupon into the app, you pull the content from a server. This allows you to change or update the coupon on the fly without needing to push an app update to your users.

Phrases and terms similar to “Bluetooth Personal Area Network (PAN)” may include the concept that Bluetooth is a wireless technology standard for exchanging data over short distances from fixed and mobile devices, and building personal area networks. A Personal Area Network is another name for a Bluetooth Piconet. Bluetooth networks are considered hardware based communications networks, whereas the App of the invention herein is a software management application, managing the users of the wireless devices access to each other such networks.

Phrases and terms similar to “Unique Establishment Location” may include the concept that the specific owner/operator establishment to which the users may congregate and join other users to explore their common interests, by communicating with another user and thereby becoming a user-member of those located therein. The beacon at this establishment is the unique ID for that establishment and location.

Phrases and terms similar to “User-Network” may include the concept of a local management App controlling the interaction of user-members and that operates on the Bluetooth “network” hardware.

Phrases and terms similar to “Bluetooth LE (BLE)” may include the concept of a specification for one type of signal that beacons transmit. There are other types of signals that power beacons (e.g. audio signals) but Bluetooth LE has the advantage that it is low energy and is ‘native’ to most modern phones and tablets.

Phrases and terms similar to “Devices” may include the concept that all devices are capable of Bluetooth LE broadcasting. But a device can include other functionality. An iPhone, for example, can be programmed to act as a beacon. But it obviously does a whole lot more. The picture may be part of the user-members personal profile.

Phrases and terms similar to “App” may include the concept of a software application of this patent operating over the Bluetooth communications system, and is designed to facilitate users' access to other users. Associated methods hereinafter may be referred to as the “user-member management application” or App.

Phrases and terms similar to “Wireless Device” may include the concept of a generic term which accomplishes wireless communication by the transfer of information between two or more points that are not connected by an electrical conductor. This encompasses various types of fixed, mobile, and portable applications, including two-way radios, cellular telephones, personal digital assistants (PDAs), cell phones, pagers, wireless web browsers, personal digital assistants, and laptop/handheld/wearable computers, and wireless networking.

Phrases and terms similar to “User” may include the concept of “user” being a generic term for a user of a wireless device prior to their Sign-Up to the software App and not logged into the user-network, at which point the user becomes a user-member. The term “user” and “user-member” is meant to be illustrative and not limiting.

Phrases and terms similar to “User-member” may include the concept of “User-member” being a generic term to differentiate the general term of user from one that has completed their Sign-Up to the software App and is a member of an active communication.

The present invention is a conventional mobile wireless communications device including a location based ad hoc network system, using a location beacon and wireless device management software. When a wireless device comes in range of the beacon signal, the wireless device will see the presence of the beacon, and when the beacon is selected, the wireless device is now enabled to potentially communicate with all other such enabled wireless devices. Then, the wireless device management application (App) of this invention, which each such enabled wireless devices will have installed, acts to manage access to and between the wireless communications devices. The communication with other such enabled wireless devices may be under anonymous conditions or with various amounts of disclosure, including personal information. Upon completion of user-member communications, either user-member may request the other user-member to allow saving the content of the completed communications session, and if refused all information will be totally deleted upon the usermembers disconnecting from each other.

User-Member Management Application: The App is installed on each wireless device, and upon entering the signal area of a beacon for a particular establishment location, the App will then display the beacon on a screen. If multiple beacons are available, they will appear on a list. After selecting a beacon from the list, every wireless device which shares that beacons particular establishment location in its App will be able to see all other wireless devices having the same particular establishment location, and displayed on the App list of user-members. Selecting a user-member from the displayed list will send a request to that user-member, requesting to begin communication. If the recipient of the request agrees, the communications may begin, or otherwise different user-member may be selected. Prior to selecting the user-member from the Apps display, the App may be adjusted to filter user-members, being selective by user-members profile, and thereby reducing the number displayed. Another function of the App is to control what type and amount of personal information may be made available to be viewed by other user-members. The App is also used to end a communications, initiating the disconnect screen to prompt either user-member that they may request the other user-member to allow saving the content of the completed communications session, and if refused all information including the ability to communicate with the user-member will be totally deleted upon the user-members disconnecting from each other.

Entering an Establishment; the beacon, having shared the particular establishment location amongst all wireless devices that have passed within the range of the beacon, the wireless devices may now be linked to each other so as to facilitate communications between them. The linking of the wireless devices by the App takes place over the Bluetooth personal area network (PAN). The usermembers may then phone, send messages, pictures, personal profile information, or any other information that has been entered into the App by the user-member on their wireless device.

Communications: The Bluetooth, Wi-Fi, or other, are considered hardware based personal area communications networks, whereas the App of the invention herein is a user-member management software application. Whereas the Bluetooth, Wi-Fi, or potentially others, uses a beacon to make available the communication network, it does not enable the App to provide user access to other users. It is to be understood that the present Bluetooth and Beacon functions, methods, and devices presented herein are well understood and may be applied by one skilled in the art.

Implementation and Operation: With that distinction explained, a wireless communications device having the capability to facilitate conventional communications and also to operate an installed application of this invention, and having at least the hardware capabilities to support Bluetooth, Wi-Fi or any other communications based transmitter and receiver. The installation of the App is accomplished by prospective users accessing the system service provider's internet App Store, or other, by using their wireless internet enabled device and performing an installation. The Sign-Up of the App is accomplished by entering information provided by the user and may be as minimal as their name or pseudonym, and email address. This information may also be provided via Facebook or LinkedIn or other related services. After entering this information, some further information is required and this particular personal information, such as the users likes and dislikes, photograph, age, etc., and is retained only on the user's wireless device. Upon completion of the Sign-Up, the App will be completely enabled on the wireless device. The user's Sign-Up information is stored on a private server database for use only by the system service provider. Now, prior to the user entering a particular establishment location, the location owner/operator will have already installed a wireless beacon which is part of a Bluetooth ad hoc wireless network. It is envisioned that a Wi-Fi hotspot may also be use to accomplish the same or better results, and multiple beacons of various types may be used together to provide more effective results. The beacon will be made available to particular establishment location as part of a marketing effort to enroll such establishments as owner/operator members. The marketing effort embraces various services and benefits offered to the owner/operator that are part of marketing this system, creating revenues for the owner/operator of a particular establishment location or chain operation and for the system service provider. When the user's wireless device App has received a particular establishment location from the onsite beacon, the App potentially alerts the user of this occurrence by an audible, vibration, both, or other signal to inform the user. This particular establishment location is used to share a common identity amongst all users that may be present at that location. All user then having the same particular establishment location received by the App may now view all usermembers present at that location, unless a user-member has chosen to not be available for listing as part of the user-members. Any user-member may then select another user-member from the available user-members presented on the App user-member list; the user-member must request a communication session with the selected recipient user-member, and wait for their acknowledgement. If the request is accepted the requesting user-member may then proceed to send text or any other communication method available through the App. The App provides and controls access to users-members through the wireless device ad hoc network hardware, acting as a user-member management application residing and operating on top of the physical ad hoc network hardware. After completion of a communications session, a user-member may establish a new communication session with other particular establishment location user-members, independent of the prior communications session and user-member. After a user-member has completed all communications sessions of interest, the user-member may leave the particular establishment location. As the user-member reaches the far zone of the beacon signal, the user-member is notified by the App that they are approaching the maximum distance of the wireless device, and will be out of the beacon signal range. The notification will act to alert the user-member that all of the prior session actions and information will be automatically deleted, with no trace of any user-member's information including the ability to communicate with any user-member, or the user-member may request a save of this communications content. During any communication session, if one or both users desire to retain any or all actions or information that may have been created during the communications session, it may be saved on the user-member's wireless device, after receiving the express permission by either or both parties, as may be required by the users′. It should also be understood that it is envisioned and within the understanding and invention concept that more than two users may communicate in the same communications session. It is to be noted and understood that for the complete operation of this ad hoc network between users; at no time is there a need to access any central membership database locally, by Internet, or by any other means of access. Other features of this beacon based ad hoc network are, potential promotional information, which may be used to create interest or reviews about a particular establishment location or products, services, promotions, etc. This ability is facilitated by the beacon being accessible by the particular establishment location owner/operator to place information of potential interest to users-members' on a cloud based server for access by or to be “pushed” to the usermembers' wireless device App. In the event that the particular establishment location has not installed a wireless beacon, the particular establishment location owner/operator may sign-up with the system service provider and then print a paper QR or barcode beacon which includes an advertisement to be attached to a wall of the establishment. In this manner this beacon may be optically scanned with the wireless device camera and also inform patrons of the system membership and they may use their wireless device to participate as a user-member. In the event the owner/operator of the particular establishment location has not installed a physical beacon, a user may elected to act as a temporary beacon, so as to facilitate the temporary ad hoc network for the use of other local users, those users just arriving and on behalf of the particular establishment location owner/operator. The operation of the ad hoc network will operate with all user-members in generally the same manner as with a physical beacon being installed at the location. This is with the exception that when the volunteer usermember beacon leaves the location, no further user-members may be enabled to be available to other existing user-members, until another user member becomes a virtual beacon.

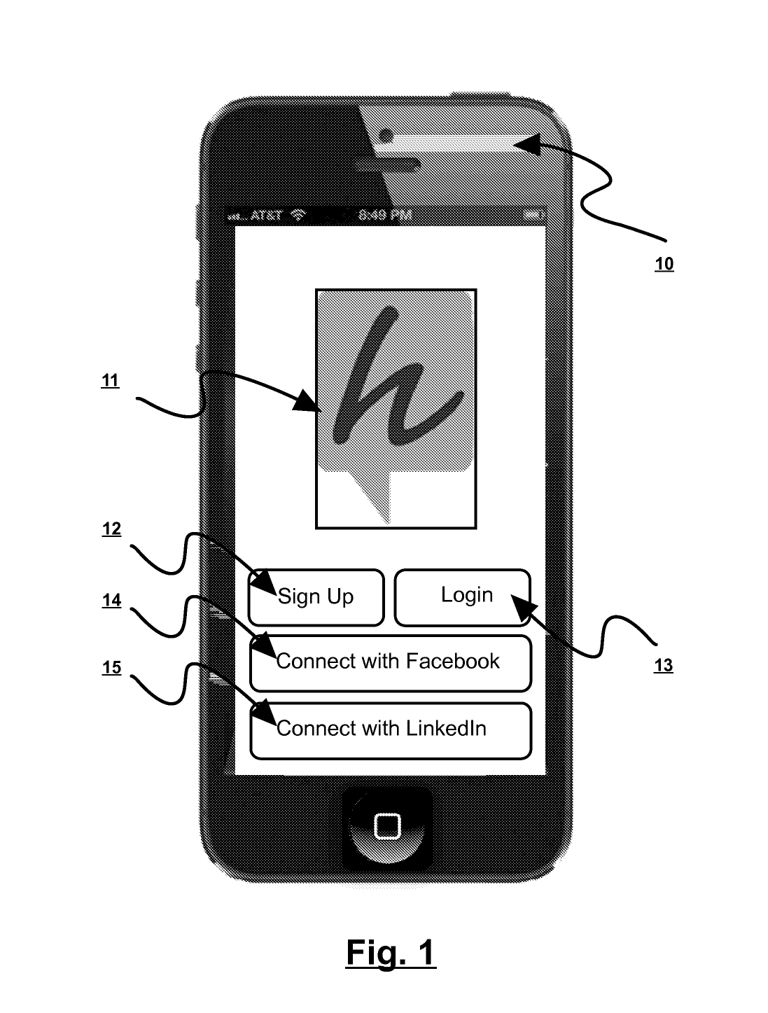

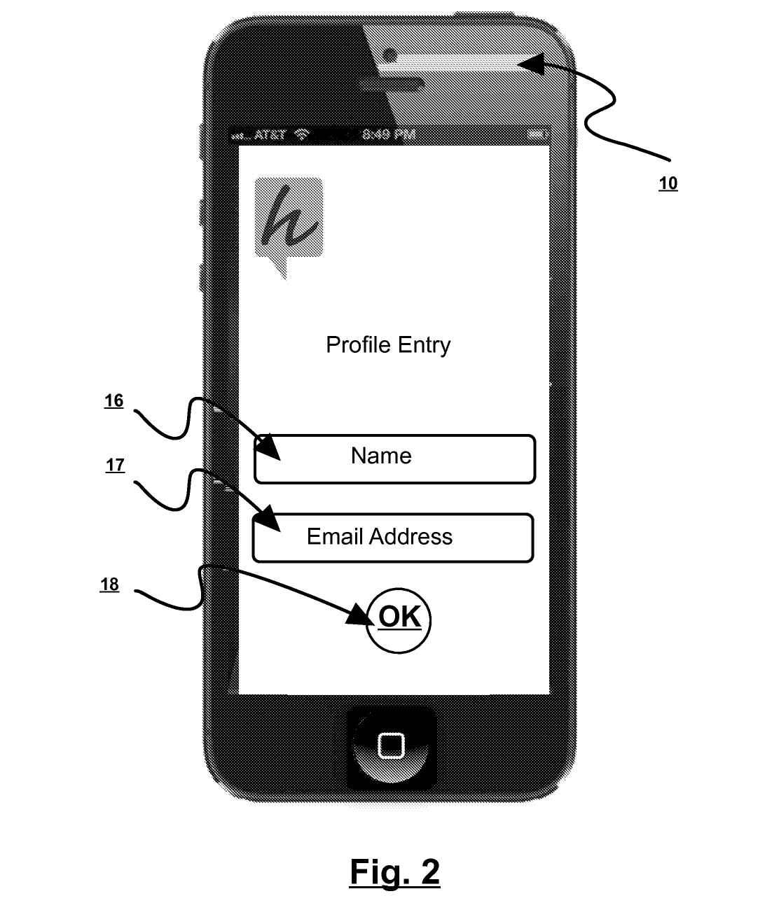

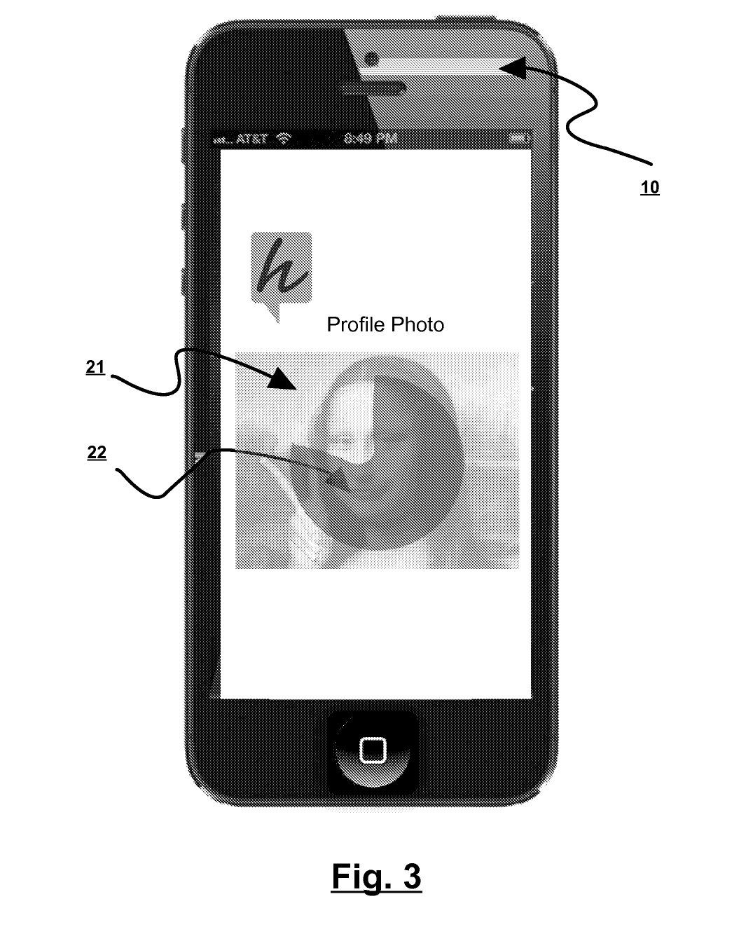

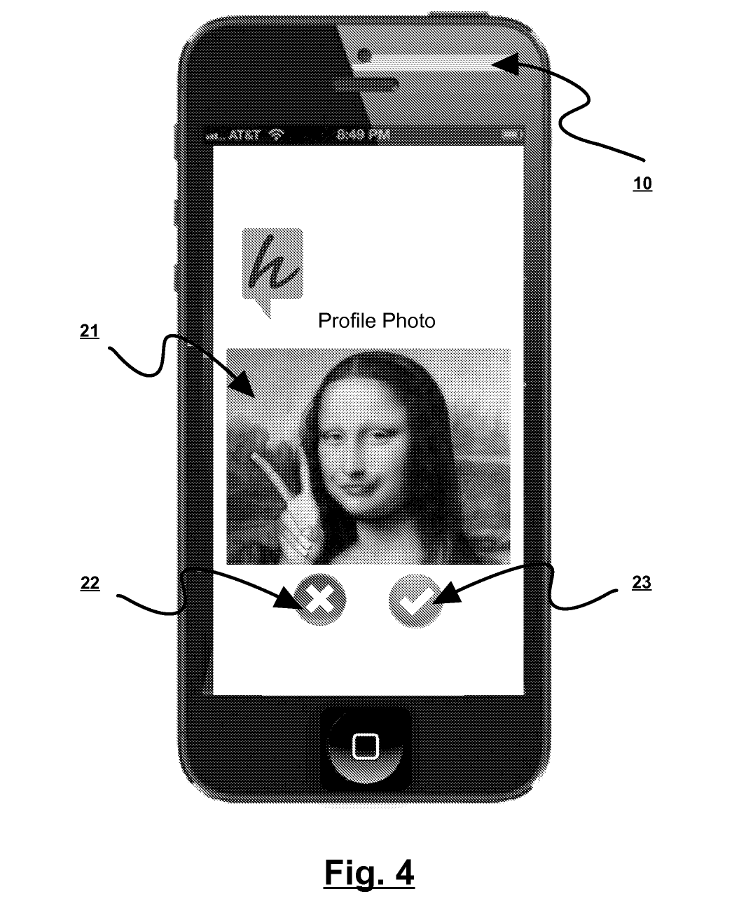

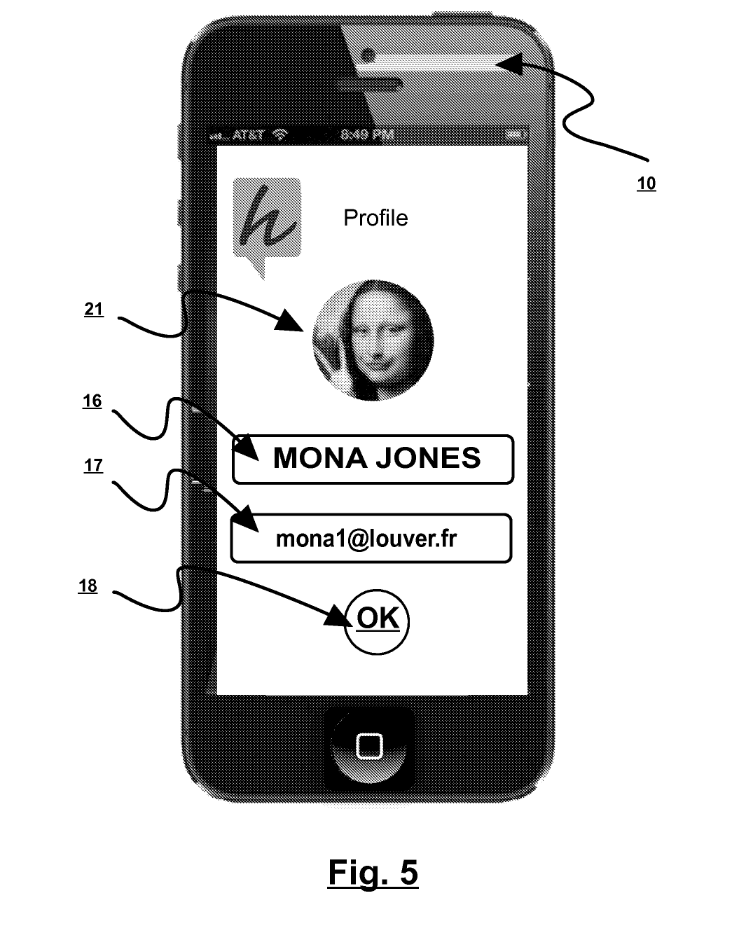

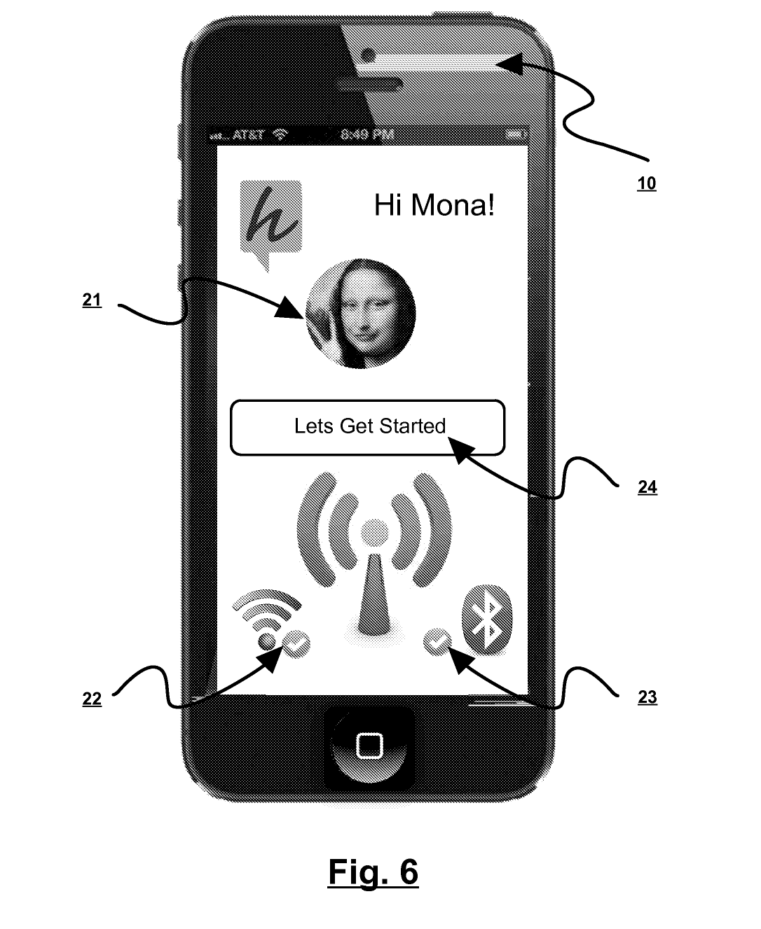

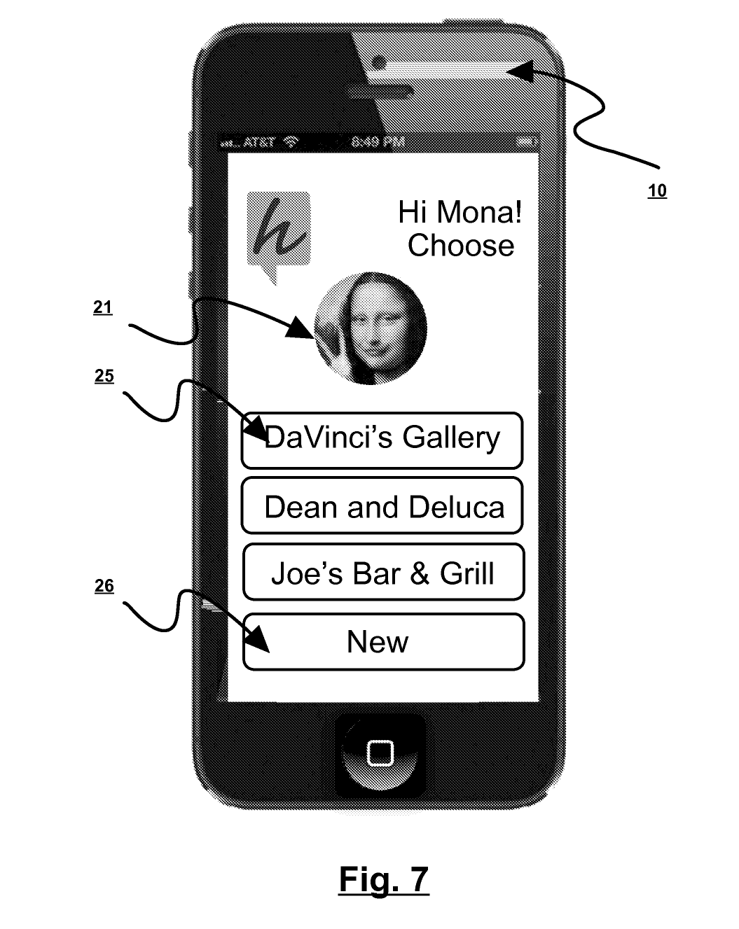

In another embodiment of this invention; referring now to the invention in more detail, referencing FIG. 1, there is shown a wireless device 10, already connected to the system service provider and selecting to Sign-Up with the App, the main screen is shown displaying the system service provider's icon 11. Buttons for Sign-Up 12, Login 13, connect with Facebook 14, connect with LinkedIn 15, provide for user interaction and may be selected by screen entry. In the event the user is a new subscriber and does not desire to use Facebook 14 or LinkedIn 15, or other sources, the user may select button “Sign-Up” 12, and on FIG. 2, enter their limited personal information on the information screen. This limited information may consist only of the user's name or pseudonym 16, their unique email address specific to the system service provider 17, this information being stored on a central server in the system service provider's database, along with an automatically generated member Sign-Up ID-code. The server and its database is not accessible by anyone but the system service provider and may not be found anywhere on the Internet or Web. When this information is completed and then clicking the button titled “OK” 18, the user is requested to provide further profile information, such as the users photograph, and likes, dislikes, and age, etc. The photograph or profile “picture” is accomplished by the App determining if wireless device has a face front camera in FIG. 3, and if so will show the live image 21, with a timer 22, illustrating when a picture will be taken, if user wants to pause the timer they just press the active timer illustration 22, and the timer will be paused enabling the user to reposition the camera field and when they are satisfied they un-pause by removing their finger from 22, to continue with taking their profile picture. Once the profile picture is taken FIG. 4, the picture 21 will be displayed on the user's wireless device screen, showing two options “X” 22, and a check mark 23. By clicking on the “X” the picture is rejected and the process to take a new picture will restart. Clicking the check mark 23 accepts the picture and the App proceeds to display the next screen FIG. 5, showing the completed user profile comprised of the name 16, unique email addresses 17, and with the addition of the user-member's picture 21. Clicking button titled “OK” 18 moves to the next screen. For simplicity, the user likes and dislikes are not shown. FIG. 6, displays the user's picture MONA 21, and the communications means in use, the default is to have booth Wi-Fi and Bluetooth enabled. The user-member may, for battery conservation purposes or any other reason, turn off either communications just by clicking the Wi-Fi check mark 22, or the Bluetooth check mark 23, to stop either service, and to turn that communications on again is accomplished with a second click. The process is completed by clicking on the “Lets Get Started” button 24, to proceed to display the next screen. The user is now fully Signed Up, may access the ad hoc network and may now be referred to as a “user-member”. FIG. 7, displays the user-member's MONA 21 choices of the locations from which the wireless device may be receiving beacon signals. Multiple locations can occur due to the location of close proximity and adjoining physical establishment locations having recognizable receivable beacons. The user-member knows which physical location they have entered and makes the correct screen selection from the Apps user-member list, and in this case its DaVinci's Gallery 25, from the displayed list of establishment locations.

There is also the possibility that no beacon is present at the particular establishment location, in which case the user may click on the “New” button 26, in order to create and operate as a temporary beacon using their wireless device. In this mode the App operates to function as a virtual beacon. The function of the user-member in this mode is to act as the physical beacon, with all of the other operations being generally the same, except that the other user-members are not able to post any comments or reviews to the cloud server, due to the fact they are not referencing any particular establishment location or owner/operator. Although, since those that are registered to the system service provider as user-members may receive discounts or promotional offered to their account record from any registered owner/operator by the service provider “pushing” the promotional to them, and may communicate with each other in the same manner as if they had accessed a physical beacon.

When the user-member's wireless device virtual beacon is moved outside of the other usermembers' location, no additional users may be added to that particular establishment locations, unless one of the other existing user-members elects to become a new temporary beacon. In this event, the App will detect this user-member's having an already existing pseudo-particular establishment location and use this in the creation of a new temporary beacon.

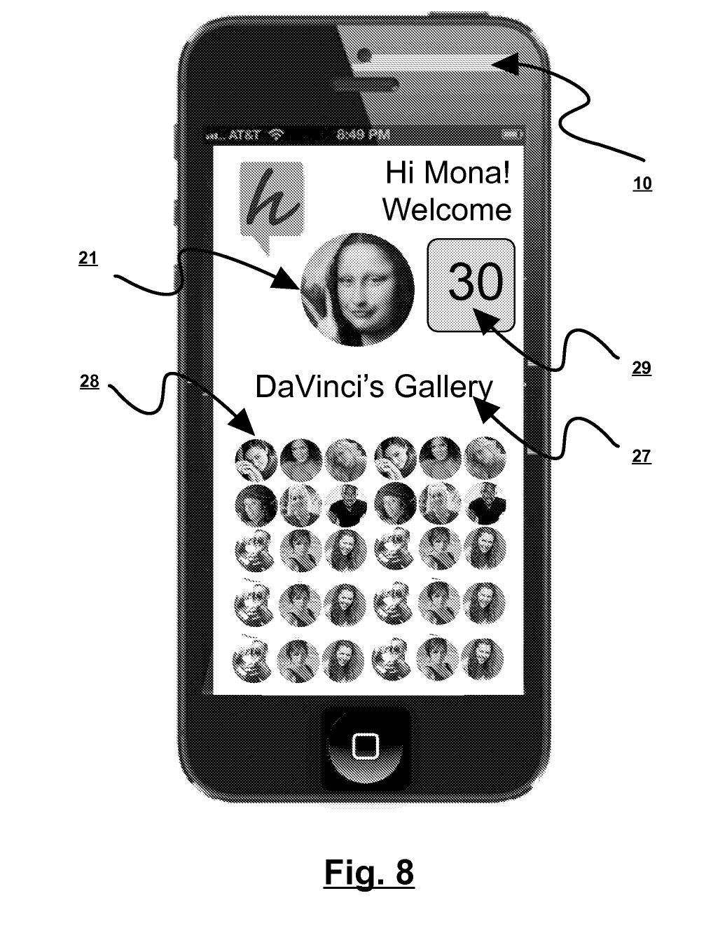

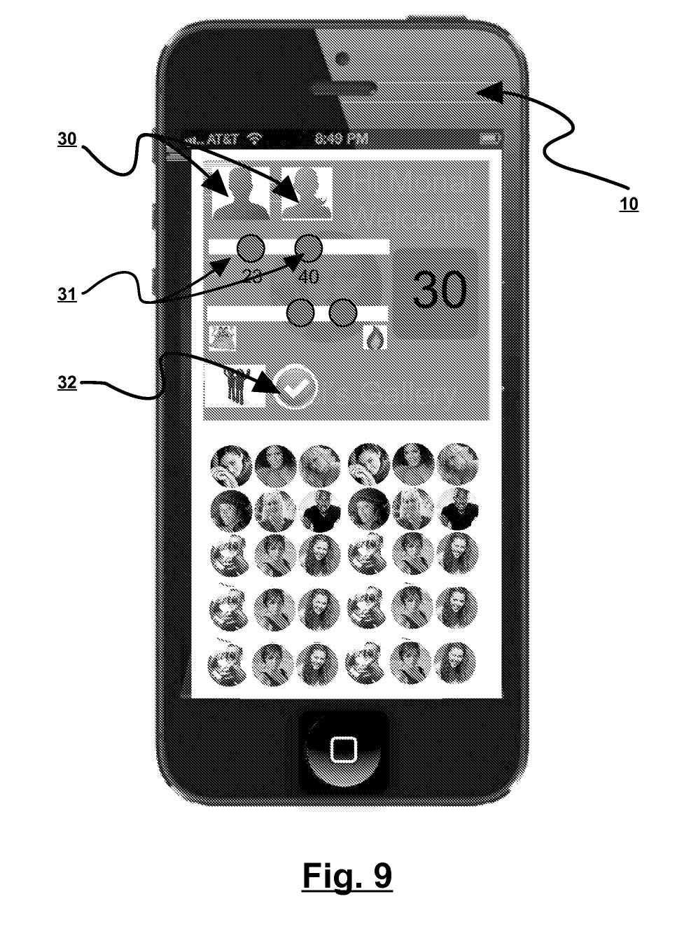

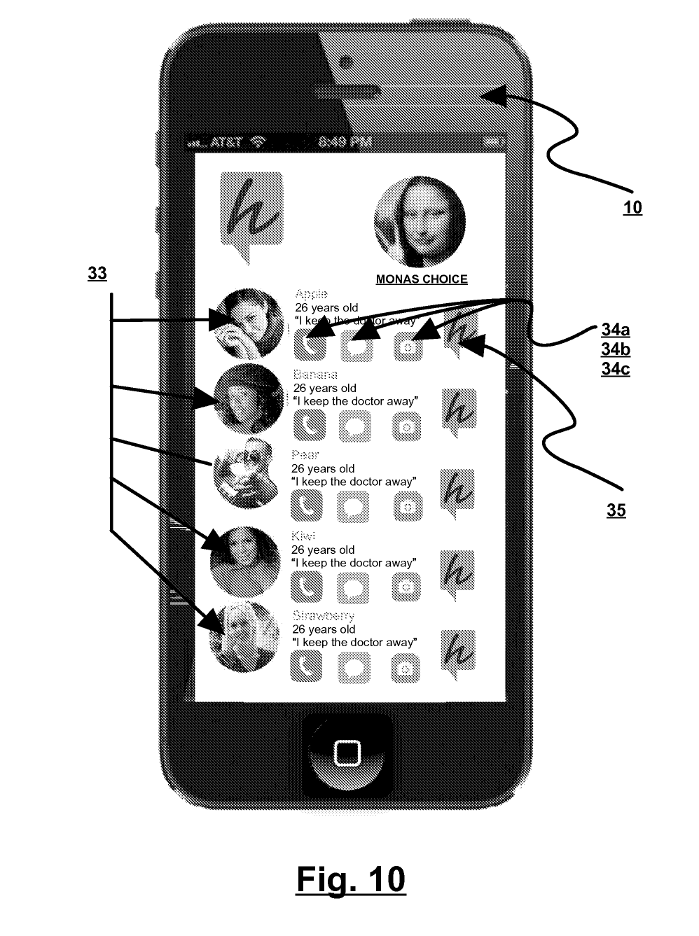

Since the user MONA 21, has previously chosen FIG. 7 the DaVinci's Gallery 25, in FIG. 8 all thirty user-members thumbnails for display screen of DaVinci's Gallery 27, are displayed for this particular establishment location at the screen bottom 28 that are user-members, the total number of which is indicated by the number of location user-members shown in the upper right corner 29. It is possible to reduce the number of user-members by using a filter based on the user-member's profiles that have been stored on each user-member's wireless device 10 by action of the App setup function. In FIG. 9, it is demonstrated and displayed that by pulling down the top of the screen like a window shade the user-member has available settings to fine-tune the desired usermembers' specific like-dislike variables for the particular establishment location. These settings may be selected by clicking or adjusting sliders as shown by selector for male or female 30, age range 31, and various other setting are envisioned. After all settings are completed, the user may click on the check button 32, to proceed to the next screen. In figure FIG. 10, the new filtered results are displayed, showing all user-members 33, that fit the new criteria in a listing with very basic profile info 34, and by what communication means the selected user-member will allow, such as voice, text, and picture transfer.

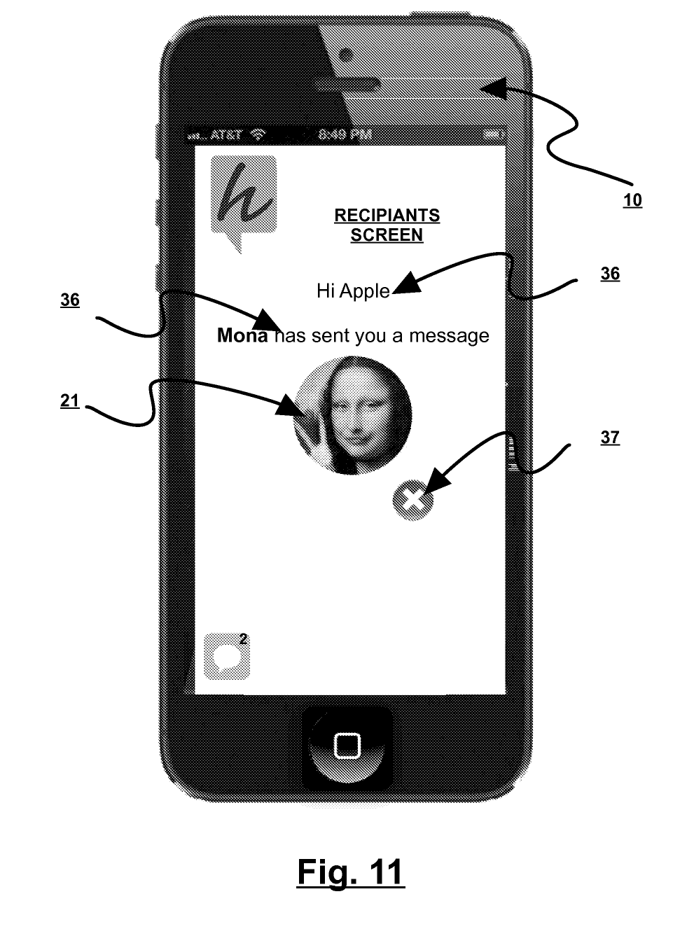

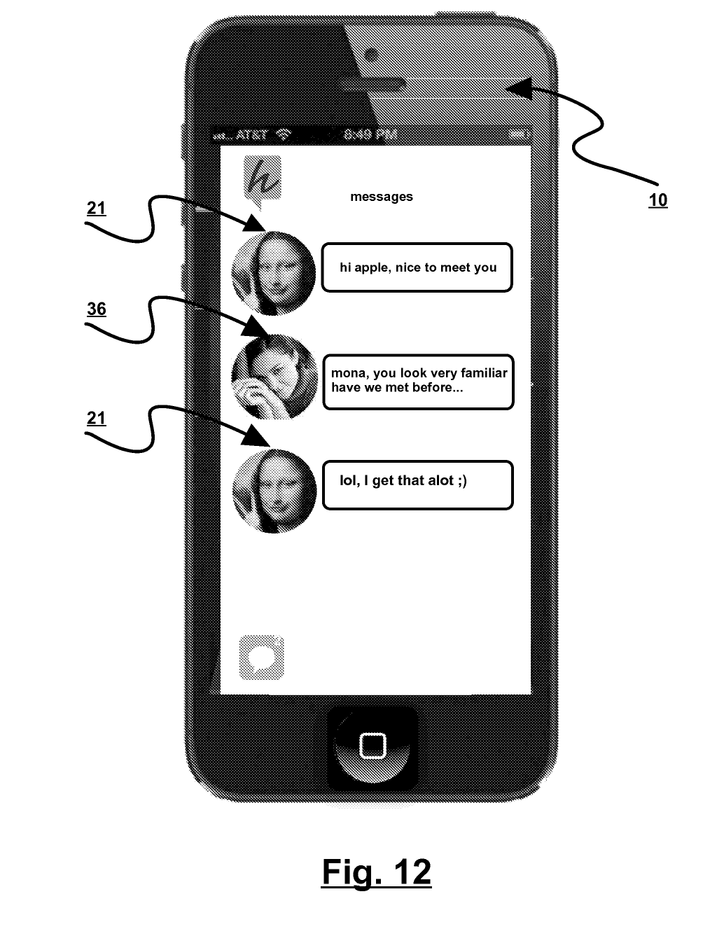

In addition a feature/function, which is not shown in a figure, is called “Safe”, which is an option for all female and under 18 year old user-members or those users-member who are concerned about disclosing their picture or other information to others, allows an approval process for communications. This feature may function as follows; the first communication would be text only messaging. Once text messages have been received by and between both user-members, then and only then may the option to send photos and make and receive voice calls be available. Prior to satisfying the Safe requirements, by text messaging, the other communication methods options of Voice and Photo share would not be a selectable communications option of the set of options 34. User-members chooses from the App list of user-members shown, the user-member they wish to contact by clicking on any of the user-member picture 33, to send a communications and by selecting a method of communication PHONE 34a, TEXT 34b, or PICTURE 34c, then clicking on the related system service provider's icon for that user-member to start the communications request process between both user-members. FIG. 11, shows the user-member recipient APPLE 36, of the communications, who is located at the particular establishment location, and now has access to all user-members. APPLE's 36 screen displays a message from MONA 21, asking the recipient user-member APPLE 36, if they wish to establish a communications with initiator MONA 21, and if they will accept the communication by clicking on the user-member MONA 21, picture that is contained in the user-member recipient's APPLE 36 screen, notification of request to communicate. If the user-member recipient APPLE 36 does not wish to communicate with the user-member MONA 21, APPLE 36 clicks on the “X” button 37, which denies the attempted communications by MONA 21, and causes a notification of the attempt being refused to be displayed on MONA 21, screen. If recipient chooses not to accept the communication request, the member will no longer be available on the App user-member list of user-members. In the event the member accepts the communication, FIG. 12, shows a common display of messages similar to other messaging applications, where the two parties MONA 21, and APPLE 36, converse showing alternate display of each user-member's picture and their associated message.

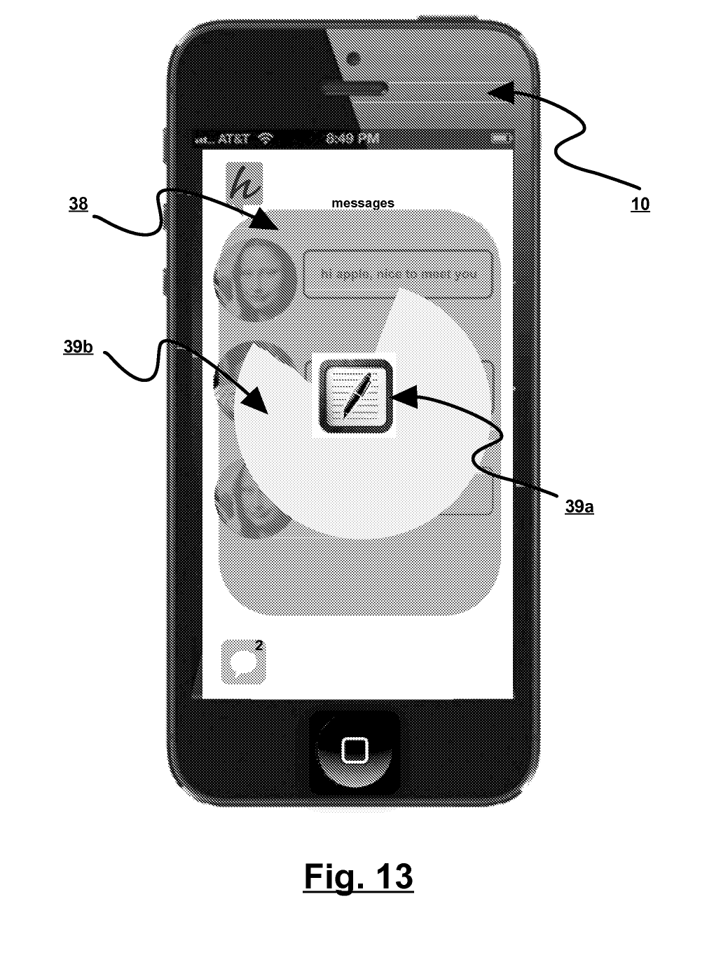

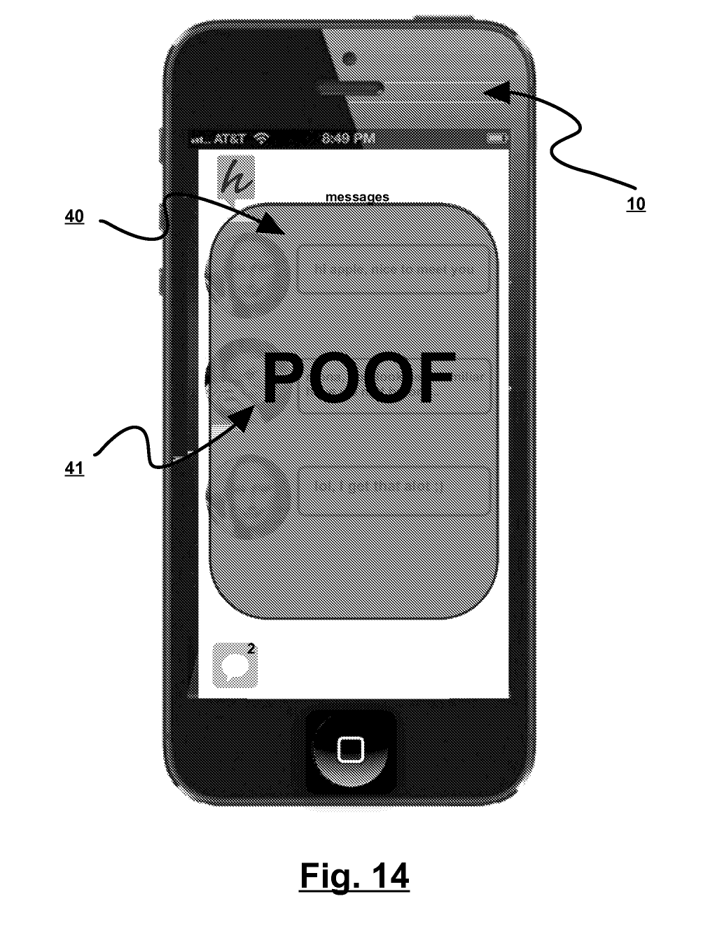

At anytime, or when either user is getting too far from each other's signal exceeding the range of the geofence FIG. 13, a screen 38 will appear above the present active screen with a timer graphic 39a and 39b (similar to the timer that appears when taking a picture), and when this timer ends all communications are terminated and all data from the present communications is completely deleted. The user-member may re-enter the beacon range while this timer is active in order to reestablish their prior user-member to user-member connection and before all data is deleted. Either user-member may request the other user-member to send their contact information or they can send the other user their contact information at this time by clicking the texting icon 39a located in the center of the timer graphic 39b including extended profile and contact information so as to be able to contact that user-member later by any other means, such as standard email address, phone, Facebook, etc. In the event the user-member sends the other user-member their information, the recipient user-member would find the information sent in their notifications screen (which is not shown in a figure). The request must be accepted in order to maintain the integrity and security of the communications. As may be seen in FIG. 14, once user-member permanently leaves the particular establishment location, their wireless device 10 screen will display a notification screen 40, indicating of loss of communications “POOF” 41, and return to the initial start screen of FIG. 7. illustrates one general overview diagram for one embodiment of the cannabis chain of custody (CCC) management device, system, and method of the disclosure described herein. More specifically, the CCC system is not limited to cannabis or marijuana and can also be applicable to the chain of custody tracking, management, and identification of all types of agricultural, plant, medicinal, food, drug, or pharmaceutical materials and end products. Here, the CCC system can include one or more cannabis taggants and extraction systems. Here, taggants can include but are not limited to physical, molecular, chemical or biological. Extraction system or extraction equipment can incorporate or include supercritical CO2 fluid extraction systems and methods.

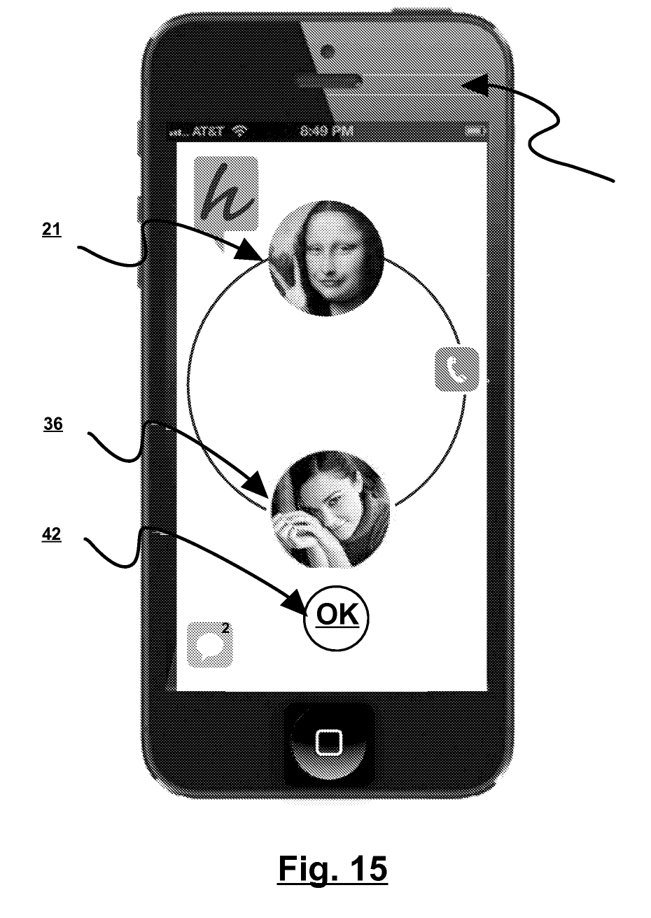

Additional App Screens: FIG. 15 shows an example screen that is one of the communications methods that may be available, as determined by the particular user-member. This screen would be presented if the method of communications was PHONE 34a, and the screen depicts the two user-members, MONA 21 and APPLE 36 speaking on a phone conversation. To complete the call, either party may click on the OK button 42 to exit the call.

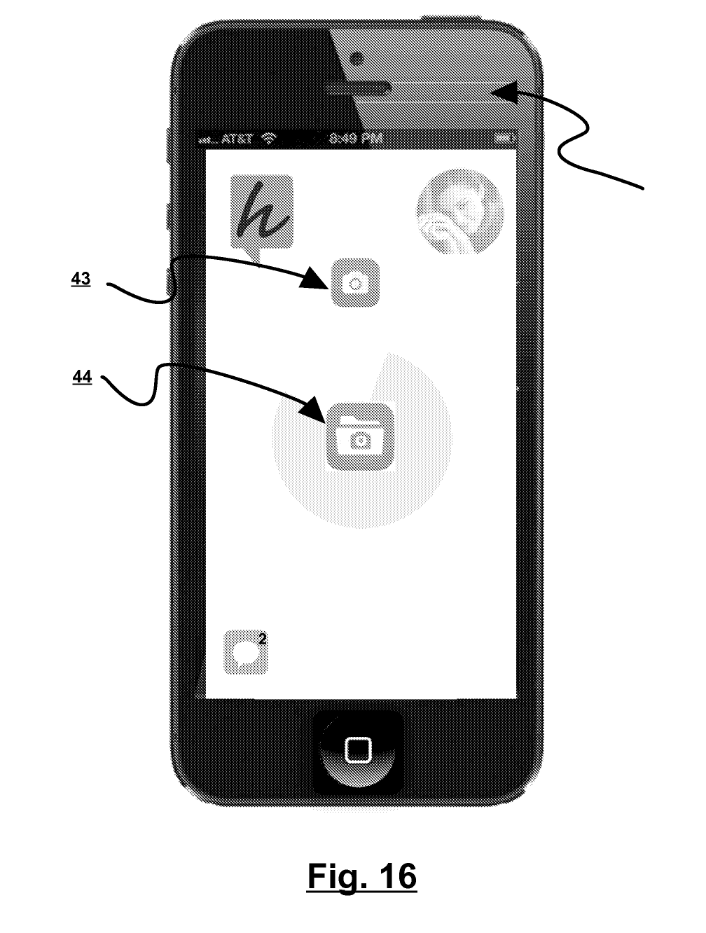

Additional App Screens: FIG. 16 shows an example screen that is one of the communications methods that may be available, as determined by the particular user-member. This screen would be presented if the method of communications was PICTURE 34c, and the screen depicts the default is set to take a picture using the face front camera and when the timer, as described earlier in this application, runs out the picture is taken and sent to APPLE 36. The user-member may pause the taking of the picture to adjust the camera by clicking on the camera icon 43, than clicking again to continue. The user-member may also decide to use an existing picture, which may be accomplished by clicking on the picture folder located in the center of the timer 44 to choose from existing picture(s) to send.

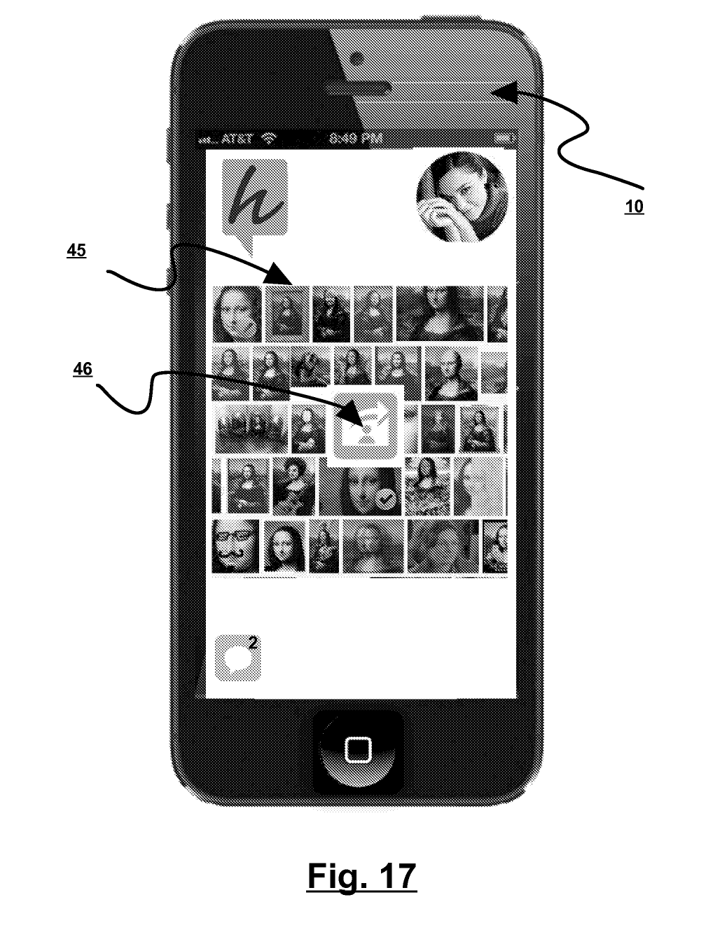

Additional App Screens: FIG. 17 is an example screen that shows what the user-member will see if they choose from FIG. 16, the option to select 44 from an existing picture. Here the user-member scrolls through their photo library 45 and clicks each picture they wish to send the recipient user-member. Upon clicking a picture, a green check mark will appear next to the chosen picture, if a picture is chosen mistakenly the user-member clicks the picture again and the check mark will disappear, and once all pictures are chosen the user-member then clicks the picture folder icon 46, located in the center to send the selected picture(s).

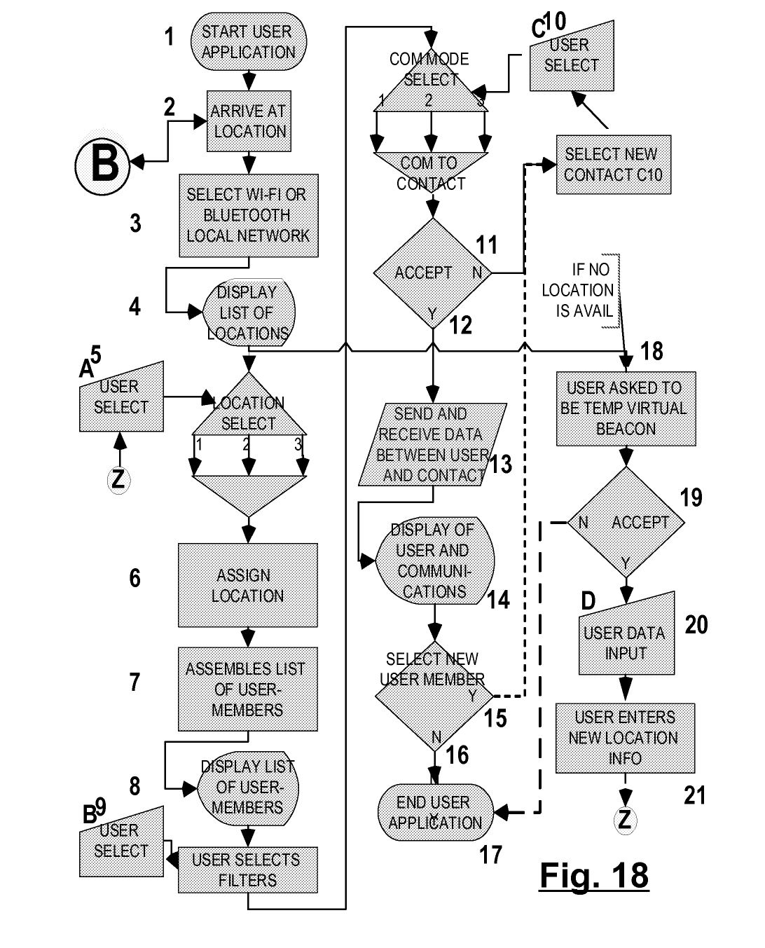

Referring now to the invention in more detail, the following is a diagram description of operation, referring now to FIG. 18, there is shown an example of another mode of operation as a flow diagram. This diagram assumes that all data has been entered into the App and is fully Signed-Up for operation by the user-member. The user-member may start 1, the application by clicking on the icon for the application herein described. Once started the user-member may arrive 2, at a particular establishment location, where the wireless device and App of this invention, receives from beacon B, the particular establishment location and the wireless device is now able to access all user-members at this establishment. The log-in may be automatic, without user intervention, in which case the App screen is displayed and the user-member may be notified by an audible alert the they have entered a geofence area that is recognized by the App. At this time, the user-member is shown a screen where they may select 3 to disable either or both Wi-Fi or Bluetooth. The user-member is now presented a screen displaying a list 4 of available particular establishment locations, more than one may be available due to their beacon proximity being close to the user-member's wireless device. The user-member clicks on a button on the wireless device screen A5, which particular establishment location to enable, determined by the particular establishment location in which they are presently standing. After making the selection the particular establishment location is assigned 6 to all following user activities. A list of all user-members is created 7 by the App and displayed 8 on the wireless device. With a significant number of user-members available at the particular establishment location, it may be desirable to reduce this total. This may be accomplished by employing filters to apply against the member user's personal profiles. The filters may be adjusted by the user-member adjusting the filter setting by entering or clicking B9 on various choices of profile buttons displayed. A reduced set of user-members are displayed and the user-member is prompted to select with which one to communicate by selecting the user and mode of communications desired C10, and a request is sent to the recipient user-member for their approval. If the request is not accepted 11, the process reverts back to the user select screen C10 to select a different user-member from the displayed list. In the event the recipient user-member does accept 12, both user-members may proceed to send messages to each other 13, which activity is displayed 14 to the user-member. After the user-members have completed all the communications they may desire, they can end the connection and select a new 15 user-member to contact, or they may exit the App 16 and leave the App network at 17. In the event that the user enters a particular establishment location that is not a registered owner/operator member with the system service provider, that user may elect to become a temporary virtual beacon 18. If not accepted 19, the user exits 17, but if accepted 19, (following functions not represented) this users' App will generate a pseudo-particular establishment location and cause their wireless device to act as a beacon for users to detect. The App will ask if the user-member desires to create a particular establishment location name for display to others 20, entering other related information 21, or just use their present user-member name. This user may now be seen on other users App's usermember list, as the user-members name or a created particular establishment location. New potential user-members may now select A5 this new pseudo-particular establishment location virtual beacon 6. After other users have selected this virtual beacon and new user-members are detected 7 may be seen as being available and selected from the App user-member list 8, these now user-members may communicate with each other. In the event the present user-member virtual beacon leaves (not shown), another present user member must become a new virtual beacon. This may be accomplished by one of the present user-members, already having the pseudo-particular establishment location, elects to become a new virtual beacon. The App recognizes the present member already has the pseudo-particular 17 establishment location, which is utilized to initialize the new virtual beacon. In this manner, new user-members may communicate with previously created user-members, those created by the original virtual beacon.

What is claimed is:

1. The invention claimed is:
A method of for authorizing communications access between at least two users mobile device equipments, the method comprising the steps of: providing one or more wireless location devices having predefined location information associated therewith, at a location substantially accessible to mobile device users;
acquiring predefined location data from at least one wireless location device via a software application residing on a first wireless user equipment, acquiring predefined location data via a software application residing on a second wireless user equipment, determining when there is a match between the acquired predefined location data of the first user equipment and the acquired predefined location data of a second user equipment, and initiating, when a match is determined, wireless communication between the first and the second user equipment, by sending to any of the user equipments a message associated with the match.
